(19) United States
(12) Patent Application Publication
(10) Pub. No.: US 2026/0195503 A1
(43) Pub. Date: Jul. 9, 2026

(54) DATA AUGMENTATION METHOD AND DATA AUGMENTATION DEVICE

(71) Applicant: SHENZHEN UNIVERSITY, Shenzhen (CN)

(72) Inventors: Mingyang ZHANG, Shenzhen (CN); Weilun WANG, Shenzhen (CN)

(73) Assignee: SHENZHEN UNIVERSITY, Shenzhen (CN)

(21) Appl. No.: 19/440,494

(22) Filed: Jan. 5, 2026

(30) Foreign Application Priority Data
Jan. 7, 2025 (CN) 202510022043.8

(51) Int. Cl. G06F 30/23; G06F 30/17; G06F 119/04

(52) U.S. Cl. CPC G06F 30/23; G06F 30/17; G06F 2119/04

(57) ABSTRACT

A data augmentation method includes: acquiring design parameters of a reinforced concrete beam member and corrosion experiment sample data of the reinforced concrete beam member conforming to the design parameters; establishing a finite element model of a reinforced concrete beam based on the design parameters; establishing a steel corrosion expansion model; and taking the steel corrosion expansion model as a boundary condition, inputting the corrosion experiment sample data into the finite element model of the reinforced concrete beam to calibrate a behavior of the finite element model of the reinforced concrete beam in simulating a surface concrete cracking caused by a concrete surface corrosion expansion, and generating augmented mapping relationship data between a calibrated spatial distribution of the steel corrosion rate and the distribution of the crack width.

### CROSS-REFERENCE TO RELATED APPLICATIONS

The present application claims priority to Chinese Patent Application No. 202510022043.8, filed on Jan. 7, 2025, the entire contents of which are incorporated herein by reference.

### TECHNICAL FIELD

The present application relates to the technical field of bridge performance prediction, and in particular to a data augmentation method and a data augmentation device.

### BACKGROUND

Steel bar corrosion is a major problem leading to the performance degradation of reinforced concrete structures. The steel bar corrosion will cause concrete cracking and spalling, reduce the bearing capacity of the structure, and thus lead to long-term performance degradation.

In the related art, common methods describe the relationship between the rust degree of steel bar and the crack width based on empirical models and mechanical models. By determining the random variables involved in predicting the steel bar rust and establishing the relationship between the amount of steel bar rust and the crack width, the uncertainty of structural performance degradation prediction is reduced. However, this method overly simplifies the prediction of the remaining service life of bridge structures because it ignores the spatial variability during the process of the steel bar corrosion.

The above content is only used to assist in understanding the technical solution of the present application and does not mean that the above content is prior art.

### SUMMARY

The main purpose of the present application is to provide a data augmentation method, aiming to solve the technical problem that the existing reinforced concrete degradation prediction method overly simplifies the prediction of the remaining service life of bridge structures.

To achieve the above purpose, the present application provides a data augmentation method, including:
acquiring design parameters of a reinforced concrete beam member and corrosion experiment sample data of the reinforced concrete beam member conforming to the design parameters, and the corrosion experiment sample data includes mapping relationship data between a spatial distribution of a steel corrosion rate and a distribution of a crack width on a surface of the reinforced concrete beam member;
establishing a finite element model of a reinforced concrete beam based on the design parameters;
establishing a steel corrosion expansion model; and
taking the steel corrosion expansion model as a boundary condition, inputting the corrosion experiment sample data into the finite element model of the reinforced concrete beam to calibrate a behavior of the finite element model of the reinforced concrete beam in simulating a surface concrete cracking caused by a concrete surface corrosion expansion, and generating augmented mapping relationship data between a calibrated spatial distribution of the steel corrosion rate and the distribution of the crack width.

In an embodiment, the acquiring the design parameters of the reinforced concrete beam member and the corrosion experiment sample data of the reinforced concrete beam member conforming to the design parameters includes:
acquiring the design parameters of the reinforced concrete beam member, and the design parameters include a member length, a cross-sectional dimension, a concrete strength, a thickness of a protection layer, and a diameter of a steel bar; and
acquiring the corrosion experiment sample data of the reinforced concrete beam member conforming to the design parameters obtained by accelerated corrosion through electrification.

In an embodiment, the acquiring the corrosion experiment sample data of the reinforced concrete beam member conforming to the design parameters obtained by accelerated corrosion through electrification includes:
acquiring first corrosion experiment sample data of the reinforced concrete beam member conforming to the design parameters obtained by accelerated corrosion through electrification under different current conditions, and the first corrosion experiment sample data includes mapping relationship data between a spatial distribution of the steel corrosion rate along a length direction of the steel bar and the distribution of the crack width under different current conditions;
determining a spatial distribution of the steel corrosion rate under different corrosion rates based on the spatial distribution of the steel corrosion rate along the length direction of the steel bar under different current conditions;
determining an average corrosion rate of the steel bar based on the spatial distribution of the steel corrosion rate under different corrosion rates; and
generating mapping relationship data between the spatial distribution of the steel corrosion rate and the distribution of the crack width based on the average corrosion rate of the steel bar.

In an embodiment, the taking the steel corrosion expansion model as the boundary condition, inputting the corrosion experiment sample data into the finite element model of the reinforced concrete beam to calibrate the behavior of the finite element model of the reinforced concrete beam simulating the surface concrete cracking caused by the concrete surface corrosion expansion, and generating augmented mapping relationship data between the calibrated spatial distribution of the steel corrosion rate and the distribution of the crack width includes:
determining the average corrosion rate of the steel bar and a standard deviation of the steel bar corrosion rate based on the corrosion experiment sample data, and determining a logarithmic function relationship between the average corrosion rate of the steel bar and the standard deviation of the steel bar corrosion rate through a fitting method;
introducing a correlation equation for a finite element simulation, and determining a correlation distance parameter of the correlation equation for the finite element simulation based on the design parameters;
taking the steel corrosion expansion model as the boundary condition, calculating an expansion displacement of each unit of the finite element model of the reinforced concrete beam based on the correlation equation for the finite element simulation to perform a finite element simulation of a process of the surface concrete cracking caused by the concrete surface corrosion expansion; and
inputting the logarithmic function relationship into the finite element model of the reinforced concrete beam, generating the spatial distribution of the steel corrosion rate conforming to the logarithmic function relationship and a corresponding distribution of the crack width, and acquiring the augmented mapping relationship data between the calibrated spatial distribution of the steel corrosion rate and the distribution of the crack width.

In an embodiment, the inputting the logarithmic function relationship into the finite element model of the reinforced concrete beam, generating the spatial distribution of the steel corrosion rate conforming to the logarithmic function relationship and the corresponding distribution of the crack width includes:

inputting the logarithmic function relationship into the finite element model of the reinforced concrete beam, and simulating variability characteristic parameters of a corrosion space through Nataf transformation to generate the spatial distribution of the steel corrosion rate conforming to the logarithmic function relationship and the corresponding distribution of the crack width.

In an embodiment, the correlation equation for the finite element simulation includes an exponential correlation function, and the exponential correlation function is specifically:

$${ρ}_{i , j} = exp ( - \frac{\vert τ \vert}{L} )$$

ρ_{i,j} is a function value of a correlation of corrosion between steel bar units, L is the correlation distance parameter of the correlation equation, and τ=xᵢ-xⱼ is a center distance between two adjacent steel bar units along the length direction of the steel bar.

In an embodiment, the establishing the finite element model of the reinforced concrete beam based on the design parameters includes:
establishing a concrete model through introducing an eight-node solid element based on the design parameters;
simulating a tensile behavior of the concrete model through introducing a linear softening curve of fracture energy based on the concrete model; and
establishing a three-dimensional finite element model of the reinforced concrete beam based on the tensile behavior of the concrete model.

In an embodiment, the establishing the steel corrosion expansion model includes:
introducing a rust distribution curve of an elliptic expression to simulate a rust expansion behavior of each cross-section of the steel bar, and establishing the steel corrosion expansion model; and the rust distribution curve of the elliptic expression is

$${u}_{θ} = \{ \begin{matrix}{u}_{2} & 0 ° \leq θ \leq 180 ° \\ \frac{( R + {u}_{1} ) \cdot ( R + {u}_{2} )}{\sqrt{{( R + {u}_{1} )}^{2} {cos}^{2} θ \cdot {( R + {u}_{2} )}^{2} {sin}^{2} θ}} - R & 180 ° < θ \leq 360 °\end{matrix}$$

u_{θ} is a function value of the rust distribution curve, R is an original radius of the steel bar, u₁ is a maximum thickness of a corrosion layer closest to a concrete surface, u₂ is a thickness of the corrosion layer on one side of the steel bar away from the concrete surface, and u_{θ} is a function value of the rust distribution curve of the elliptic expression.

In an embodiment, the taking the steel corrosion expansion model as the boundary condition, inputting the corrosion experiment sample data into the finite element model of the reinforced concrete beam to calibrate the behavior of the finite element model of the reinforced concrete beam simulating the surface concrete cracking caused by the concrete surface corrosion expansion, and generating augmented mapping relationship data between the calibrated spatial distribution of the steel corrosion rate and the distribution of the crack width includes:
taking the steel corrosion expansion model as the boundary condition, inputting the corrosion experiment sample data into the finite element model of the reinforced concrete beam to calibrate the behavior of the finite element model of the reinforced concrete beam simulating surface concrete cracking caused by concrete surface corrosion expansion, cyclically executing the step of generating the augmented mapping relationship data between the calibrated spatial distribution of the steel corrosion rate and the distribution of the crack width, and stopping executing the step of generating the augmented mapping relationship data between the calibrated spatial distribution of the steel corrosion rate and the distribution of the crack width after a data volume of the augmented mapping relationship data reaches a preset target data volume.

In addition, to achieve the above purpose, the present application also provides a data augmentation device, including: a memory, a processor, and a computer program stored on the memory and executable on the processor, and the computer program is configured to implement the data augmentation method described above.

One or more technical solutions provided in the present application have at least the following technical effects:
acquiring design parameters of a reinforced concrete beam member and corrosion experiment sample data of the reinforced concrete beam member conforming to the design parameters, wherein the corrosion experiment sample data includes mapping relationship data between a spatial distribution of a steel corrosion rate and a distribution of a crack width on a surface of the reinforced concrete beam member;
establishing a finite element model of a reinforced concrete beam based on the design parameters;
establishing a steel corrosion expansion model;
taking the steel corrosion expansion model as a boundary condition, inputting the corrosion experiment sample data into the finite element model of the reinforced concrete beam to calibrate a behavior of the finite element model of the reinforced concrete beam in simulating a surface concrete cracking caused by a concrete surface corrosion expansion, and generating augmented mapping relationship data between a calibrated spatial distribution of the steel corrosion rate and the distribution of the crack width.

Thus, the present application realizes data augmentation of the mapping relationship between the spatial distribution of the steel corrosion rate and the distribution of the crack width, and provides a data foundation for establishing the relationship model between the spatial distribution of the steel corrosion rate and the distribution of the crack width. Therefore, the corrosion status of internal steel bars can be predicted through the surface crack width, and probabilistic prediction of the long-term performance of reinforced concrete structures can be realized.

### BRIEF DESCRIPTION OF THE DRAWINGS

The accompanying drawings herein are incorporated into the specification and constitute a part of the specification, showing embodiments consistent with the present application, and are used together with the specification to explain the principles of the present application.

In order to illustrate the technical solutions in the embodiments of the present application or in the related art more clearly, the following briefly introduces the accompanying drawings required for the description of the embodiments or the related art. Obviously, for those skilled in the art, other drawings can also be obtained according to these drawings without any creative effort.

FIG. 1 is a schematic flowchart of a data augmentation method according to an embodiment of the present application.

FIG. 2 is a schematic structural diagram of a reinforced concrete beam member according to an embodiment of the present application.

FIG. 3 is a schematic structural diagram of a three-dimensional finite element model of the reinforced concrete beam generated in the data augmentation method according to an embodiment of the present application.

FIG. 4 is a schematic structural diagram of a steel corrosion expansion model generated in the data augmentation method according to an embodiment of the present application.

FIG. 5 is a diagram of a spatial distribution of a steel corrosion rate generated in the data augmentation method according to an embodiment of the present application.

FIG. 6 is a scatter diagram of data samples of an augmented mapping relationship between a calibrated spatial distribution of the steel corrosion rate and a distribution of a crack width generated in the data augmentation method according to an embodiment of the present application.

FIG. 7 is a schematic device structure diagram of a hardware operating environment involved in the data augmentation method according to an embodiment of the present application.

The realization of the objective, functional characteristics, and advantages of the present application are further described with reference to the accompanying drawings.

### DETAILED DESCRIPTION OF THE EMBODIMENTS

It should be understood that the specific embodiments described herein are only used to explain the technical solution of the present application, and are not used to limit the present application.

To better understand the technical solution of the present application, a detailed description will be given below with reference to the accompanying drawings and specific implementations.

The main solution of the embodiment of the present application is: acquiring design parameters of a reinforced concrete beam member, and acquiring experimental parameters based on the design parameters; establishing a three-dimensional finite element model of the reinforced concrete beam based on the design parameters and experimental parameters; establishing a steel corrosion expansion model based on the three-dimensional finite element model of the reinforced concrete beam; and determining a first mapping relationship between the spatial distribution of the steel corrosion rate and the distribution of the crack width based on the steel corrosion expansion model.

Technical terms involved in the embodiments of the present application are as follows.

Nataf transformation is a technique used in numerical calculation and probabilistic analysis, which can be applied in finite element analysis. When performing numerical calculations, it is often necessary to solve the uncertainty propagation problem caused by the uncertainty of geometric shape, boundary conditions, or material parameters. The core idea of the Nataf transformation is to convert the uncertainty of random variables into variables with known distribution through linear transformation, making the problem easier to handle in the new variable space. Specifically, the Nataf transformation converts original random variables into new variables by introducing a linear transformation matrix, so that the correlation structure between the new variables is simpler or easier to handle. In this way, the original problem can be transformed into solving in the new variable space, thereby simplifying the processing and solving process of the problem.

Inverse marginal cumulative distribution function of the standard Gaussian distribution refers to the inverse function of a given probability value in the standard Gaussian distribution, which returns the variable value of the standard Gaussian distribution corresponding to the given probability. The standard Gaussian distribution, also known as the normal distribution or bell curve, is a common continuous probability distribution in statistics. Its probability density function is a bell curve, symmetric about the mean, with two parameters: mean and standard deviation. In the standard Gaussian distribution, the mean is 0 and the standard deviation is 1. In statistics, the inverse marginal cumulative distribution function (CDF) accepts a probability value (usually between 0 and 1) and then returns the variable value corresponding to the probability value. In other words, the inverse CDF provides a reverse mapping that converts probability into variable values.

Monte Carlo method is a numerical calculation method based on random sampling, used to solve various complex problems, especially in the field of probability and statistics. Specifically, the Monte Carlo method simulates the uncertainty or randomness of a problem by generating a large number of random samples, and then performs numerical calculations through these samples to obtain an approximate solution to the problem. The core idea of this method is to approximate the behavior of a complex system through random sampling, thereby solving problems that are difficult to solve with traditional numerical methods. Although the results of the Monte Carlo method are approximate, more and more accurate results can be obtained with the increase of the number of samples.

Cholesky decomposition is a numerical decomposition method used to decompose a symmetric positive definite matrix into the product of a lower triangular matrix and its transpose, which can be used to solve linear equations, calculate the determinant of a matrix, and perform least squares fitting.

Finite element method is a numerical analysis technique that divides a complex continuous system into many simple geometric units called finite elements. Each finite element represents a small part of the system, and its behavior can be approximated by a simple mathematical description. These finite elements form a grid or mesh network through connecting nodes, and the entire system is discretized into a finite number of finite elements. In the finite element method, the behavior of each finite element is mathematically modeled and connected together to form a model of the entire system. This model is usually expressed as a system of linear or nonlinear algebraic equations, whose solution describes the behavior of the system. By numerically solving this system of equations, an approximate solution of the system can be obtained.

Fitting method is a set of statistical techniques used to determine the relationship between observed data and one or more theoretical models, and use these models to predict or explain unknown data. Fitting methods are usually used to find the mathematical function or curve that best fits the observed data, and these functions or curves can be used to predict or infer unknown data. Common fitting methods include the least square method, nonlinear least square method, polynomial fitting method, and local fitting method.

In the embodiments of the present application, for the convenience of expression, the following description will be made with the data augmentation device that identifies the data augmentation method as the execution subject.

In a chloride environment, steel bar rust is a major cause of performance degradation of reinforced concrete structures, and has become a global problem in the past few decades. The repair cost of reinforced concrete structures affected by corrosion is quite high. The annual cost of maintaining and repairing concrete infrastructure affected by corrosion worldwide exceeds 100 billion US dollars. In the high-alkaline environment of concrete, the passive film of the steel bar is relatively stable. However, when the passive film is damaged due to chloride ion erosion, the steel bar will corrode. The volume expansion of corrosion products will cause cracking and even spalling of the protective layer concrete. Corrosive media outside the structure can more easily reach the surface of the steel bar, accelerating the corrosion process. With the significant decrease in the cross-sectional area of the steel bar and the bond strength between the concrete and the steel bar, the bearing capacity also decreases, resulting in the failure of service performance and the degradation of long-term structural performance.

In structural detection methods, visual inspection is a low-cost and general technique for evaluating the degradation degree of existing steel bar structures, and has been widely used in formulating maintenance strategies for existing bridges. For corroded reinforced concrete structures, the concrete surface crack width caused by the steel bar corrosion is the most commonly used visual inspection index. Many researchers have tried to link the crack width with the rust state of the steel bar (i.e., loss of the cross-sectional area), and provided many empirical models and mechanical models to describe the relationship between the degree of steel bar rust and the crack width. Once the random variables involved in predicting steel bar rust are determined and the relationship between the amount of the steel bar rust and the rust crack width is established, update theory and nonlinear filtering can be applied to reduce the uncertainty of structural performance degradation prediction.

Due to the combined influence of various factors, such as different environmental exposure conditions, thickness of the protection layer of the concrete, and construction quality, the corrosion of steel bars presents a spatially non-uniform distribution characteristic, and the corrosion crack width on the bridge structure surface also presents random and non-uniform distribution characteristics. The structural bearing capacity of bridge members strongly depends on the local conditions of their steel bars. Thus, ignoring the spatial variability of steel bar corrosion will overly simplify the prediction of the remaining service life of bridge structures.

The present application provides a solution that can augment the currently limited experimental data through numerical simulation to establish a database of the mapping relationship between the spatial distribution of the steel corrosion rate and the distribution of the crack width. Specifically, acquiring design parameters of a reinforced concrete beam member and corrosion experiment sample data of the reinforced concrete beam member conforming to the design parameters, the corrosion experiment sample data includes mapping relationship data between a spatial distribution of a steel corrosion rate and a distribution of a crack width on a surface of the reinforced concrete beam member; establishing a finite element model of a reinforced concrete beam based on the design parameters; establishing a steel corrosion expansion model; taking the steel corrosion expansion model as a boundary condition, inputting the corrosion experiment sample data into the finite element model of the reinforced concrete beam to calibrate a behavior of the finite element model of the reinforced concrete beam in simulating a surface concrete cracking caused by a concrete surface corrosion expansion, and generating augmented mapping relationship data between a calibrated spatial distribution of the steel corrosion rate and the distribution of the crack width. Thus, the present application realizes data augmentation of the mapping relationship between the spatial distribution of the steel corrosion rate and the distribution of the crack width, and provides a data foundation for establishing the relationship model between the spatial distribution of the steel corrosion rate and the distribution of the crack width. Therefore, the corrosion status of internal steel bars can be predicted through surface crack width, and probabilistic prediction of the long-term performance of reinforced concrete structures can be realized.

It should be noted that the execution subject of this embodiment may be a computing service device with data processing, network communication, and program running functions, such as a tablet computer, a personal computer, a mobile phone, etc., or an electronic device capable of realizing the above functions. Hereinafter, the data augmentation device will be taken as an example to describe this embodiment and the following embodiments.

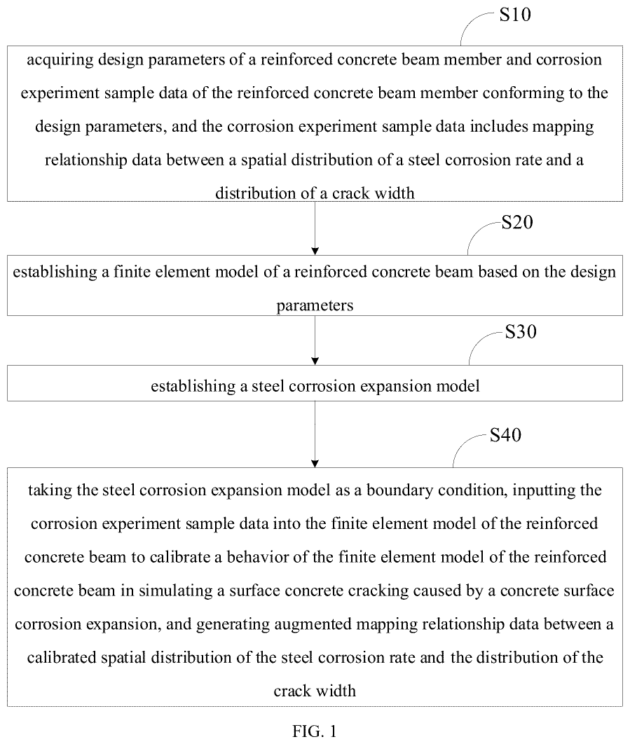

Based on this, the embodiment of the present application provides a data augmentation method for the mapping relationship between the distribution of the steel bar corrosion and the distribution of the crack width. Referring to FIG. 1, the data augmentation method for the mapping relationship between the distribution of the steel bar corrosion and the distribution of the crack width includes steps S10~S40:

Step S10: acquiring design parameters of a reinforced concrete beam member and corrosion experiment sample data of the reinforced concrete beam member conforming to the design parameters, and the corrosion experiment sample data includes mapping relationship data between a spatial distribution of a steel corrosion rate and a distribution of a crack width on a surface of the reinforced concrete beam member.

It should be noted that acquiring the design parameters of the reinforced concrete beam member may include acquiring the member length, cross-sectional dimension (such as width, height, length), concrete strength (such as concrete of different strengths such as C25 and C30), thickness of the protection layer, steel bar diameter, type of steel bar, yield strength and tensile strength of the steel bar, reinforcement ratio (number, diameter, spacing of main reinforcement and stirrup), and placement position of the steel bar. Thus, based on the similarity theory, the scale of the experimental model can be designed to ensure that the model can reflect the mechanical behavior of the prototype in the experiment, and the environmental conditions of the experiment (such as temperature, humidity, medium, etc.) can be set. An accelerated corrosion experiment through electrification can be carried out, and an image acquisition device can be arranged at the bottom of the concrete beam member to obtain the occurrence and width change of cracks on the surface of the reinforced concrete beam member, so as to obtain corrosion experiment sample data. It can be understood that the internal steel bar corrosion status of the reinforced concrete beam member can be detected by X-ray. It can be understood that experiments can be carried out based on various predetermined schemes, and changes of all key corrosion experiment sample data can be recorded to evaluate changes in steel bar corrosion, morphology and width changes of surface cracks, etc. In this embodiment, the spatial distribution data of the steel corrosion rate, the distribution of the crack width of the reinforced concrete beam member conforming to the design parameters, and the mapping relationship data between the spatial distribution data of the steel corrosion rate and the distribution of the crack width can be acquired after the experiment.

Step S20: establishing a finite element model of a reinforced concrete beam based on the design parameters.

In this embodiment, when establishing the three-dimensional finite element model of the reinforced concrete beam, to reduce the complexity of establishing the three-dimensional finite element model of the reinforced concrete beam, some parameters that have little influence on acquiring the mapping relationship between the distribution of the steel bar corrosion and the distribution of the crack width can be ignored, assumed, or simulated and replaced by similar methods. For example, since the compressive behavior of concrete has little influence on the calculation result of the crack width caused by corrosion, the compressive behavior of concrete can be assumed to be an ideal elastic material. The corrosion expansion can be regarded as displacement applied on the interface layer between the steel bar and concrete. Therefore, when establishing the three-dimensional finite element model of the reinforced concrete beam, the steel bar can be simulated as a hole, and the non-uniform corrosion around the steel bar and along the steel bar axis can be simulated by applying radial displacement to represent the spatial expansion of steel bar corrosion. For another example, several assumptions can be made in the simulation of the corrosion expansion process, including: rust can be regarded as rigid, and its deformation can be ignored; the influence of corrosion of longitudinal steel bars on the corrosion-induced crack width near adjacent longitudinal steel bars is not considered, and only the relationship between the distribution of the steel corrosion rate of longitudinal steel bars and the corrosion-induced crack width is taken into account; and the influence of stirrups on the crack width is ignored in the finite element model. Thus, this embodiment can simplify the complexity of establishing the three-dimensional finite element model of the reinforced concrete beam, and does not affect the subsequent analysis of the mapping relationship between the distribution of the steel bar corrosion and the distribution of the crack width based on the three-dimensional finite element model of the reinforced concrete beam.

Step S30: establishing a steel corrosion expansion model.

In an embodiment, the step S30 includes:

step S31: introducing a rust distribution curve of an elliptic expression to simulate a rust expansion behavior of each cross-section of the steel bar, and establishing the steel corrosion expansion model; and the rust distribution curve of the elliptic expression is:

$${u}_{θ} = \{ \begin{matrix}{u}_{2} & 0 ° \leq θ \leq 180 ° \\ \frac{( R + {u}_{1} ) \cdot ( R + {u}_{2} )}{\sqrt{{( R + {u}_{1} )}^{2} {cos}^{2} θ \cdot {( R + {u}_{2} )}^{2} {sin}^{2} θ}} - R & 180 ° < θ \leq 360 °\end{matrix}$$

u_{θ} is a function value of the rust distribution curve, R is an original radius of the steel bar, u₁ is a maximum thickness of a corrosion layer closest to a concrete surface, u₂ is a thickness of the corrosion layer on one side of the steel bar away from the concrete surface, and u_{θ} is a function value of the rust distribution curve of the elliptic expression.

It should be noted that the elliptic expression, as a continuous function, can more accurately describe the inhomogeneity of rust expansion of the cross-section of the steel bar, and can reflect the complex distribution characteristics of rust on the cross-section of the steel bar, such as the coexistence of local severe rust and slight rust, thereby simulating the difference of the influence of local rust on the structure. The shape of the semi-ellipse is determined by the ratio u₂/u₁, and u₂/u₁ can be assumed to equal to 1/30.

Step S40: taking the steel corrosion expansion model as a boundary condition, inputting the corrosion experiment sample data into the finite element model of the reinforced concrete beam to calibrate a behavior of the finite element model of the reinforced concrete beam in simulating a surface concrete cracking caused by a concrete surface corrosion expansion, and generating augmented mapping relationship data between a calibrated spatial distribution of the steel corrosion rate and the distribution of the crack width.

It should be noted that in the simulation of the corrosion expansion process of the steel bar, after the steel bar starts to rust, the rust can expand freely. Once the voids in the porous zone are completely filled with rust, the expansion of rust will exert pressure on the surrounding concrete, thereby generating tensile stress and causing concrete cracking. Not all rust will lead to an increase in stress and initial cracking of the protection layer of the concrete. Some rust may penetrate into the porous zone between the steel bar and the surrounding concrete. This method assumes that the porous zone is uniform, and the thickness δ of the porous zone can be 12.5 μm. In the free expansion stage of rust products, the rust volume Vᵣᵤₛₜ₁ per unit length/can be:

$${V}_{rust 1} = {V}_{p o r o} + {V}_{steel 1}$$

Vₚₒᵣₒ is the volume of rust products infiltrating into the porous zone at the steel/concrete interface (i.e., 2πRδl), and Vₛₜₑₑₗ₁ is the volume of the steel bar corroded in the free expansion stage of rust products. Once the voids in the porous zone are completely filled with rust, tensile stress will be generated in the surrounding concrete. After the voids are filled with rust, the rust volume Vᵣᵤₛₜ₂ per unit length l is:

$${V}_{rust 2} = {V}_{e x p} + {V}_{steel 2}$$

$${V}_{e x p} = ω Rl ( {u}_{1} + 3 {u}_{2} ) / 2$$

Vₑₓₚ is the expansion volume per unit length l, Vₛₜₑₑₗ₂ is the volume of the steel bar corroded after the voids are filled with rust, u₁ is the maximum thickness of the corrosion layer closest to the concrete surface, u₂ is the thickness of the corrosion layer on the side away of the steel bar from the concrete surface, and R is the original radius of the steel bar. The total rust volume Vᵣᵤₛₜ=Vᵣᵤₛₜ₁+Vᵣᵤₛₜ₂ comes from three interrelated processes, each of which is directly or indirectly related to steel bar rust. Specifically, firstly, the total rust volume includes the relevant rust occupying the consumed steel bar. The rust occurs directly on the surface of the steel bar, and the volume of rust products is larger than the original volume of the steel bar, leading to the expansion of the solid volume of the steel bar itself. Secondly, the total rust volume includes the relevant rust infiltrating into the porous zone at the steel bar/concrete interface. The iron oxide generated during the rust process can penetrate into the tiny gaps or pores between the steel bar and concrete from the surface of the steel bar. This penetration will further aggravate the bond damage between the steel bar and concrete, and may also form rust channels, promoting the intrusion of more moisture and corrosive media and accelerating the rust process. Thirdly, the total rust volume includes the relevant rust that exerts expansion pressure on the surrounding concrete. The volume expansion of rust products will exert pressure on the surrounding concrete, leading to concrete cracking or spalling, and reducing the integrity and durability of the structure. Since all rust is generated by steel bar rust, the relational expression is:

$${V}_{rust} = β {V}_{steel}$$

Vᵣᵤₛₜ is the total rust volume, Vᵣᵤₛₜ is the volume of all corroded steel bars, and β is the volume expansion ratio of corrosion products, which can be assumed to be 2.0.

Some rust will flow out of the structure through cracks caused by corrosion and penetrate into the surrounding concrete. The amount of rust penetrating into the surrounding concrete depends on different experimental conditions. For example, when an accelerated corrosion experiment through electrification is carried out, the amount of rust penetrating into the surrounding concrete depends on the current density level during the experiment. A lower current density is likely to provide an opportunity for rust to fill the pores of the surrounding concrete. On the contrary, when the current density is higher, some rust is not easy to induce cracking of the surrounding concrete. Therefore, the corrosion rate η′ in the expansion simulation is not the same as the corrosion rate η measured in the experiment. To simplify this problem, a calibration coefficient φ can be introduced to consider the influence of the impact current density I_{corr} and the average corrosion rate of the steel bar ηₐ on the pressure causing corrosion cracks. The relationship between η and η′ can be:

$${η}^{′} = {φ}^{- 1} η$$

$$φ = {ξ}_{1} + {ξ}_{2} {η}_{a} + {ξ}_{3} {I}_{c o r r}^{{ξ}_{4}}$$

η′ is the corrosion rate in the expansion simulation, η is the corrosion rate measured in the experiment, φ is the calibration coefficient, Icorr is the impact current density, ηₐ is the average corrosion rate of the steel bar, ξ₁ can be 0.903, ξ₂ can be 10.3, ξ₃ can be 24.2, and ξ₄ can be −0.663.

u₁ is the maximum thickness of the corrosion layer closest to the concrete surface. Taking u₁ as the first parameter of the rust layer model, u₁ can be input into the finite element model. u₁ is determined by η, and the relational expression is:

$${u}_{1} = 10 ( 2 R {φ}^{- 1} η - 4 δ ) / 11$$

η is the corrosion rate measured in the experiment, φ is the calibration coefficient, R is the original radius of the steel bar; δ is the thickness of the porous zone, which can be specifically 12.5 μm.

In an embodiment, the step S40 includes:

Step S41: taking the steel corrosion expansion model as the boundary condition, inputting the corrosion experiment sample data into the finite element model of the reinforced concrete beam to calibrate the behavior of the finite element model of the reinforced concrete beam simulating surface concrete cracking caused by concrete surface corrosion expansion, cyclically executing the step of generating the augmented mapping relationship data between the calibrated spatial distribution of the steel corrosion rate and the distribution of the crack width, and stopping executing the step of generating the augmented mapping relationship data between the calibrated spatial distribution of the steel corrosion rate and the distribution of the crack width after a data volume of the augmented mapping relationship data reaches a preset target data volume. Thus, multiple sets of augmented mapping relationship data can be obtained.

In this embodiment, taking the steel corrosion expansion model as the boundary condition, the rust distribution of the finite element model of the reinforced concrete beam is simulated and calculated. In addition, the corrosion rate simulated in the finite element model of the reinforced concrete beam can be calibrated through the mapping relationship data between the spatial distribution of the steel corrosion rate and the distribution of the crack width in the corrosion experiment sample data, so as to obtain more accurate augmented data of the relationship between the spatial distribution of the steel corrosion rate and the distribution of the crack width. Thus, this embodiment realizes data augmentation of the mapping relationship between the spatial distribution of the steel corrosion rate and the distribution of the crack width, and provides a data foundation for establishing the relationship model between spatial distribution of the steel corrosion rate and the distribution of the crack width. Therefore, the corrosion status of internal steel bars can be predicted through surface crack width, and probabilistic prediction of the long-term performance of reinforced concrete structures can be realized.

In an embodiment, the step S10 includes steps S11~S12:
Step S11: acquiring the design parameters of the reinforced concrete beam member, and the design parameters include a member length, a cross-sectional dimension, a concrete strength, a thickness of a protection layer, and a diameter of a steel bar; and
Step S12: acquiring the corrosion experiment sample data of the reinforced concrete beam member conforming to the design parameters obtained by accelerated corrosion through electrification.

In this embodiment, the accelerated corrosion experiment through electrification can simulate the corrosion process in the natural environment by applying direct current, and accelerate the corrosion rate of the steel bar. The positive electrode is connected to the steel bar, and the negative electrode is connected to the electrolyte (such as simulated seawater or sodium sulfate solution) to form an electrolytic cell, which can accelerate the anodic dissolution process of the steel bar. Electrochemical techniques such as electrochemical impedance spectroscopy (EIS) and linear polarization resistance (LPR) can be used to regularly measure the corrosion current density of the steel bar, and the average corrosion rate of the steel bar and its distribution can be calculated in combination with the weight loss method. The inhomogeneity of the corrosion rate will lead to the corrosion rate of the steel bar in some areas being much higher than that in other areas. The internal corrosion status of the reinforced concrete beam member can be detected. During the corrosion of the steel bar, the crack width around the steel bar corrosion area generally presents a non-uniform distribution, which corresponds to the distribution of the steel bar corrosion rate. The crack width near the corrosion hot spot area (area with high corrosion rate) is generally larger. In this embodiment, acquiring the corrosion experiment sample data of the reinforced concrete beam member conforming to the design parameters obtained by accelerated corrosion through electrification can provide corrosion experiment sample data support for subsequent statistical analysis and finite element analysis simulation to quantify the mapping relationship between the spatial distribution of the steel corrosion rate and the distribution of the crack width.

In an embodiment, the step S12 includes steps S121~S124:
Step S121: acquiring first corrosion experiment sample data of the reinforced concrete beam member conforming to the design parameters obtained by accelerated corrosion through electrification under different current conditions, and the first corrosion experiment sample data includes mapping relationship data between a spatial distribution of the steel corrosion rate along a length direction of the steel bar and the distribution of the crack width under different current conditions.

It should be noted that the experimenter can energize the reinforced concrete beam under different current conditions to simulate the corrosion process of the steel bar in the actual environment. Since the current can accelerate the corrosion rate of the steel bar, the corrosion rate and degree can be controlled by adjusting the current magnitude. During the experiment, the distribution of the corrosion rate of the steel bar along its length direction and the accompanying distribution of the crack width will be recorded. These data constitute the first corrosion experiment sample data and are input into the data augmentation device.
Step S122: determining a spatial distribution of the steel corrosion rate under different corrosion rates based on the spatial distribution of the steel corrosion rate along the length direction of the steel bar under different current conditions;
Step S123: determining an average corrosion rate of the steel bar based on the spatial distribution of the steel corrosion rate under different corrosion rates; and
Step S124: generating mapping relationship data between the spatial distribution of the steel corrosion rate and the distribution of the crack width based on the average corrosion rate of the steel bar.

It can be understood that for the reinforced concrete beam member under high current conditions, the corrosion rate of the steel bar is faster, while for the reinforced concrete beam member under low current conditions, the corrosion rate of the steel bar is relatively slow. In this embodiment, the data augmentation device can obtain the average corrosion rate of the steel bar based on the first corrosion experiment sample data, so as to identify the corrosion rate distribution law under different corrosion rate conditions, and then generate the mapping relationship data between the spatial distribution of the steel corrosion rate and the distribution of the crack width.

In an embodiment, the step S40 includes steps S41~S44:
Step S41: determining the average corrosion rate of the steel bar and a standard deviation of the steel bar corrosion rate based on the corrosion experiment sample data, and determining a logarithmic function relationship between the average corrosion rate of the steel bar and the standard deviation of the steel bar corrosion rate through a fitting method;
Step S42: introducing a correlation equation for a finite element simulation, and determining a correlation distance parameter of the correlation equation for the finite element simulation based on the design parameters;
Step S43: taking the steel corrosion expansion model as the boundary condition, calculating an expansion displacement of each unit of the finite element model of the reinforced concrete beam based on the correlation equation for the finite element simulation to perform a finite element simulation of a process of the surface concrete cracking caused by the concrete surface corrosion expansion; and
Step S44: inputting the logarithmic function relationship into the finite element model of the reinforced concrete beam, generating the spatial distribution of the steel corrosion rate conforming to the logarithmic function relationship and a corresponding distribution of the crack width.

In this embodiment, the statistical characteristic parameter (i.e., standard deviation) can be obtained based on the sample data of the spatial distribution of the steel corrosion rate, and the logarithmic function relationship between the standard deviation of the corrosion rate and the average corrosion rate can be determined by a fitting method, which can be specifically determined as:

$$υ = 0.08 {η}_{a}^{0.5}$$

ν is the standard deviation of the steel bar corrosion rate, i.e., the first function value; ηₐ is the average corrosion rate of the steel bar.

In an embodiment, the step S42 includes:
step S421: the correlation equation for the finite element simulation includes an exponential correlation function, and the exponential correlation function is:

$${ρ}_{i , j} = exp ( - \frac{\vert τ \vert}{L} )$$

ρ_{i,j} is the function value of the correlation of corrosion between steel bar units, L is the correlation distance parameter of the correlation equation, and τ=xᵢ-xⱼ is the center distance between two adjacent steel bar units along the length direction of the steel bar.

In an embodiment, the step S44 includes:
Step S441: inputting the logarithmic function relationship into the finite element model of the reinforced concrete beam, and simulating variability characteristic parameters of a corrosion space through Nataf transformation to generate the spatial distribution of the steel corrosion rate conforming to the logarithmic function relationship and the corresponding distribution of the crack width.

It should be noted that due to the great uncertainty of steel bar corrosion along the length direction of the steel bar, it is necessary to simulate in a probabilistic method, and the spatial variability of steel bar corrosion can be simulated by a logarithmic distribution. The logarithmic distribution combined with the Nataf transformation method can consider the corrosion correlation between steel bar units in the simulation. The corrosion correlation between steel bar units can be presented by a correlation equation for the finite element simulation, and the exponential correlation function is used to represent ρ_{i,j}:

$${ρ}_{i , j} = exp ( - \frac{\vert τ \vert}{L} )$$

ρ_{i,j} is the function value of the correlation of corrosion between steel bar units, L is the correlation distance parameter of the correlation equation, and τ=xᵢ-xⱼ is the center distance between two adjacent steel bar units along the length direction of the steel bar.

It should be noted that the Nataf transformation can be used to convert any random variable into a standard Gaussian distribution. The marginal cumulative distribution function of an n-dimensional correlated random vector X=[X₁, X₂, . . . , Xₙ] is F_{X}_{ᵢ} (xᵢ), and the correlation coefficient matrix is ρ[=ρ_{i,j}]. Through the Nataf transformation, X can be converted into independent standard normal variables Y=[Yᵢ]. The process of Nataf transformation is: the correlated standard normal variables Y=[Yᵢ] can be transformed from X through the following formula:

$${y}_{j} = {Φ}^{- 1} ( {F}_{{X}_{i}} ( {x}_{i} ) )$$

yⱼ is the array element of [Yᵢ], F_{X}_{ᵢ} (xᵢ) is the marginal cumulative distribution function, and Φ⁻¹ (⋅) is the inverse marginal cumulative distribution function of the standard Gaussian distribution. The correlation coefficient matrix of Y is ρ₀=[ρ_{0i,j}]. The relationship between ρ_{i,j} and ρ_{0i,j} is as follows:

$${ρ}_{i , j} = {\int }_{- ∞}^{∞} {\int }_{- ∞}^{∞} \frac{{F}_{i}^{- 1} ( Φ ( {y}_{i} ) ) - {m}_{{x}_{i}}}{{s}_{{x}_{i}}} \cdot \frac{{F}_{j}^{- 1} ( Φ ( {y}_{j} ) ) - {m}_{{x}_{j}}}{{s}_{{x}_{j}}} {ϕ}_{2} ( {y}_{i} , {y}_{j} ; {ρ}_{0 i , j} ) d {y}_{i} d {y}_{j}$$

φ₂(yᵢ, yⱼ; ρ_{0i,j}) is given by the equation:

$${ϕ}_{2} ( {y}_{i} , {y}_{j} ; {ρ}_{0 i , j} ) = \frac{1}{\sqrt{{( 2 π )}^{n} det ( {ρ}_{0} )}} exp ( - \frac{1}{2} {y}^{T} {ρ}_{0}^{- 1} y )$$

mₓ_{ᵢ} and mₓ_{ⱼ} are the means of the correlated variables xᵢ and xⱼ respectively; sₓ_{ᵢ} and sₓ_{ⱼ} are the standard deviations of the correlated variables xᵢ and xᵢ respectively.
ρ_{0i,j} can be calculated by ρ_{i,j}, and the relationship between them can be simplified by the following formula:

$${ρ}_{0 i , j} = {P}_{j , k} \cdot {ρ}_{i , j}$$

P_{i,j} can be estimated by polynomial approximation as the following formula:

$${P}_{i , j} = \frac{{ρ}_{0 i , j}}{{ρ}_{i , j}} = {p}_{1} {ρ}_{i , j}^{3} + {p}_{2} {ρ}_{i , j}^{2} + {p}_{3} {ρ}_{i , j} + {p}_{4}$$

The parameters p₁ to p₄ can be calculated by the Monte Carlo method. The obtained ρ_{0i,j} can be decomposed, and the ρ₀ is decomposed into a lower triangular matrix and an upper triangular matrix by Cholesky decomposition, as shown in the following formula:

$${ρ}_{0} = A \cdot {A}^{T}$$

A=[a_{i,j}] is a lower triangular matrix. Therefore, the variable Y can be expressed as the product of A and independent standard normal variables U, as shown in the following formula:

$$Y = A \cdot u$$

The relationship between the independent standard normal variables U and the original correlated variables X can be established as the equation:

$${X}_{1} = {F}_{{X}_{1}}^{- 1} ( Φ ( {a}_{11} {U}_{1} ) )$$

$${X}_{2} = {F}_{{X}_{2}}^{- 1} ( Φ ( {a}_{21} {U}_{1} + {a}_{22} {U}_{2} ) )$$

$${X}_{n} = {F}_{{X}_{n}}^{- 1} ( Φ ( {a}_{n 1} {U}_{1} + {a}_{n 2} {U}_{2} + … + {a}_{n n} {U}_{n} ) )$$

In this embodiment, simulation is performed by a probabilistic method, and the logarithmic distribution combined with the Nataf transformation method can consider the corrosion correlation between steel bar units in the simulation to simulate the variability characteristic parameters of the corrosion space, and generate the spatial distribution of the steel corrosion rate conforming to the logarithmic function relationship and the corresponding distribution of the crack width based on this, so as to obtain augmented mapping relationship data between the calibrated spatial distribution of the steel corrosion rate and the distribution of the crack width.

In an embodiment, the step S20 includes steps S21~S23:
Step S21: establishing a concrete model through introducing an eight-node solid element based on the design parameters;
Step S22: simulating a tensile behavior of the concrete model through introducing a linear softening curve of fracture energy based on the concrete model; and
Step S23: establishing a three-dimensional finite element model of the reinforced concrete beam based on the tensile behavior of the concrete model.

In this embodiment, during finite element analysis, the concrete structure can be divided into multiple three-dimensional eight-node solid elements. Each element has eight vertices, which can more accurately capture complex geometric shapes and stress distributions. The concrete exhibits nonlinear behavior during tensile process, especially brittle fracture after reaching the limit state. This embodiment describes the process of concrete from the occurrence of microcracks to complete fracture by adopting a linear softening curve, that is, the phenomenon that the stress-strain relationship of the concrete gradually softens (i.e., stress decreases while strain continues to increase). Introducing fracture energy (G_{f}) can measure the ability of the material to absorb energy before fracture to quantify this softening behavior. The crack width parameter h is introduced, which can be used to represent the width of crack development in the concrete. In this embodiment, the crack width h is simply defined as the cube root of the grid element volume, aiming to ensure that the crack width is matched with the discretization degree of the model and improve the rationality of the simulation.

It should be noted that the Joint Committee of the International Council for Concrete and the European Concrete Committee (CEB-FIP) model code is one of the international standards for concrete structure design and analysis. The 2010 version of the model code provides a method for calculating concrete fracture energy. This embodiment can accurately evaluate the energy absorption capacity of concrete during the fracture process through the 2010 version of the model. The concrete can be assumed to be an ideal elastic material under compression, ignoring the plastic deformation or damage that actual concrete may occur under high pressure, so as to simplify the data analysis of the model and focus on the tensile and corrosion problems of concrete. In this embodiment, the volume expansion caused by the steel bar corrosion can be simulated by applying displacement at the interface between the steel bar and the concrete. Thus, the non-uniform expansion behavior caused by the corrosion is considered, and the spatial change of this corrosion phenomenon along the steel bar axis is simulated.

In this embodiment, in the process of establishing the finite element model, the steel bar is not directly modeled as a solid, but a hole is created at its position (i.e., the space occupied by the steel bar is deducted), and the expansion effect of the steel bar is simulated by applying radial displacement to the concrete elements around the hole. This simplifies the modeling of the interaction between the steel bar and the concrete, and can effectively capture the complex stress state caused by the steel bar corrosion. Thus, this embodiment provides a numerical simulation method for establishing a three-dimensional finite element model of the reinforced concrete beam, aiming to comprehensively analyze the mechanical response of the reinforced concrete structure under the action of steel bar corrosion, including crack formation, expansion, and the interaction between concrete and steel bar, and provides an important data foundation for determining the first mapping relationship between the distribution of the steel bar corrosion and the distribution of the crack width.

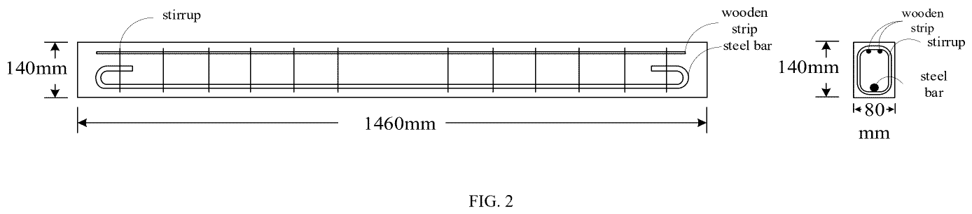

In an embodiment of the present application, please refer to FIG. 2, FIG. 2 is a schematic structural diagram of a reinforced concrete beam member according to an embodiment of the present application. The reinforced concrete beam member shown in FIG. 2 includes a longitudinal steel bar, the cross-section of the beam is 80×140 mm², and the length of the beam is 1460 mm.

It should be noted that the mapping relationship data between the spatial distribution of the steel corrosion rate and the distribution of the crack width on the surface of the reinforced concrete beam member under different corrosion degrees can be acquired by the accelerated corrosion experiment through electrification. Specifically, multiple sets of corrosion experiment sample data can be acquired by adopting different experimental conditions in the experiment. For example, the diameter of the steel bar can be 13 mm or 19 mm, the thickness of the protection layer of the steel bar can be 10 mm or 20 mm, and the energizing current density can be 10r thickness be acquired by adopting different experimental conditions.

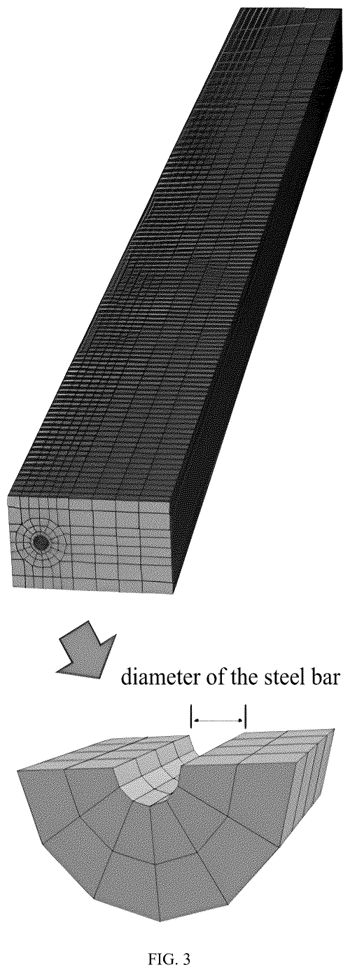

Referring to FIG. 3, FIG. 3 is a schematic structural diagram of a three-dimensional finite element model of the reinforced concrete beam generated in the data augmentation method according to an embodiment of the present application. In this embodiment, a correlation equation for the finite element simulation can be introduced, and the correlation distance parameter of the correlation equation for the finite element simulation can be determined based on the design parameters. 31.4 mm can be selected as the correlation distance parameter, and the corrosion rate of each unit along the length direction of the steel bar can be calculated and generated. The Nataf transformation method can be introduced to simulate the variability characteristic parameters of the corrosion space, so as to generate the spatial distribution of the steel corrosion rate conforming to the logarithmic function relationship and the corresponding distribution of the crack width.

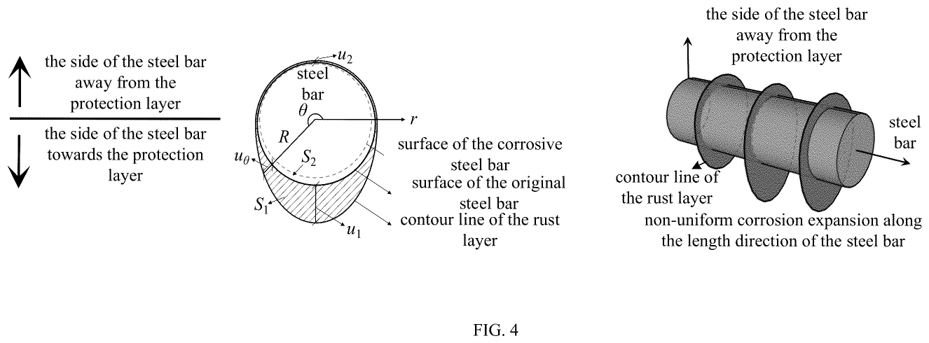

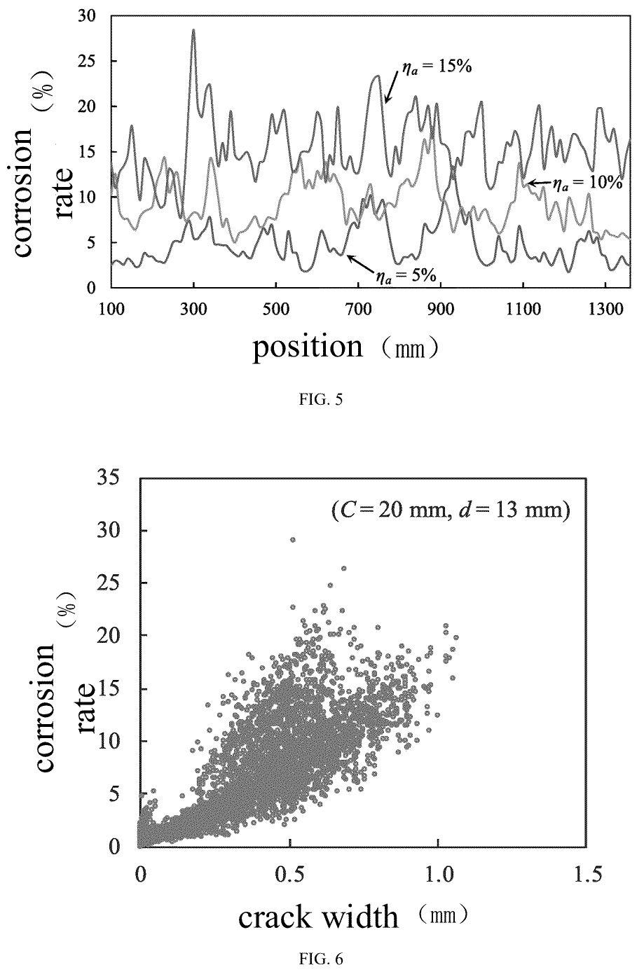

Please refer to FIG. 4 and FIG. 5, FIG. 4 is a schematic structural diagram of a steel corrosion expansion model generated in the data augmentation method according to an embodiment of the present application, and FIG. 5 is a diagram of a spatial distribution of a steel corrosion rate generated in the data augmentation method according to an embodiment of the present application. The steel bar can be simulated as a hole, and the non-uniform corrosion around the steel bar and along the steel bar axis can be simulated by applying radial displacement to represent the spatial expansion of steel bar corrosion. The spatial distribution of the steel corrosion rate is substituted into the steel corrosion expansion model by means of a calibration coefficient, and the expansion displacement data of the unit nodes applied at the reinforced concrete interface is calculated to simulate the corrosion expansion of the steel bar. u_{θ} in FIG. 4 is the function value of the rust distribution curve (i.e., the function value of the rust layer thickness), R is the original radius of the steel bar, u₁ is the maximum thickness of the corrosion layer closest to the concrete surface, u₂ is the thickness of the corrosion layer on the side of the steel bar away from the concrete surface, S₁ is the partial area of the steel bar that actually loses the effective cross-sectional area after corrosion; S₂ is the area occupied by the rust layer after the steel bar is corroded; θ represents the angle, and r represents the polar coordinate system. FIG. 5 shows the spatial distribution of the steel corrosion rate along the length direction of the steel bar when the average corrosion rate of the steel bar ηₐ is 5%, 10%, and 15% respectively.

Referring to FIG. 6, FIG. 6 is a scatter diagram of data samples of an augmented mapping relationship between a calibrated spatial distribution of the steel corrosion rate and a distribution of a crack width generated in the data augmentation method according to an embodiment of the present application. The spatial distribution of the steel corrosion rate under different corrosion degrees can be generated through multiple samplings, and the concrete surface crack width results generated under each corrosion distribution can be corresponding one by one. The data augmentation of the first mapping relationship between the distribution of the steel bar corrosion (i.e., different corrosion rates) and the distribution of the crack width can be acquired as shown in FIG. 6. C is the thickness of the protection layer, and d is the diameter of the steel bar. The sequence-to-sequence mapping database obtained in this embodiment can be used as a training data set for neural network model (sequence-to-sequence data mode) training. The spatial distribution of the steel corrosion rate inside the concrete structure can be predicted through surface detection of the crack width, so as to realize probabilistic prediction of the long-term performance of the concrete structure.

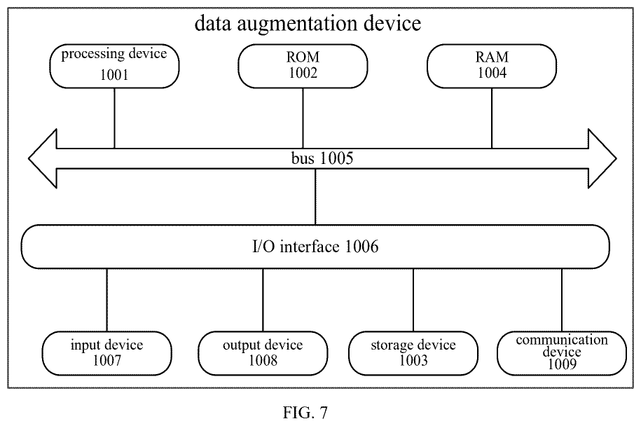

Please refer to FIG. 7, which shows a schematic device structure diagram of a hardware operating environment involved in the data augmentation method according to an embodiment of the present application. The data augmentation device may include a processing device 1001 (such as a central processing unit, a graphics processing unit, etc.), which can execute various appropriate actions and processes according to a program stored in a read-only memory (ROM) 1002 or a program loaded into a random access memory (RAM) 1004 from a storage device 1003. In the RAM 1004, various programs and data required for the operation of the data augmentation device are also stored. The processing device 1001, the ROM 1002, and the RAM 1004 are connected to each other through a bus 1005. An input/output (I/O) interface 1006 is also connected to the bus 1005. Usually, the following systems can be connected to the I/O interface 1006: an input device 1007 including, for example, a touch screen, a touch pad, a keyboard, a mouse, an image sensor, a microphone, an accelerometer, a gyroscope, etc.; an output device 1008 including, for example, a liquid crystal display (LCD), a speaker, a vibrator, etc.; a storage device 1003 including, for example, a magnetic tape, a hard disk, etc.; and a communication device 1009. The communication device 1009 can allow the data augmentation device to perform wireless or wired communication with other devices to exchange data. Although FIG. 7 shows a data augmentation device with various systems, it should be understood that it is not required to implement or have all the shown systems. It can alternatively implement or have more or fewer systems.

The data augmentation device provided by the present application adopts the data augmentation method in the above embodiment, and can solve the technical problem that the existing reinforced concrete degradation prediction method overly simplifies the prediction of the remaining service life of bridge structures. Compared with the related art, the beneficial effect of the data augmentation device provided by the present application is the same as that of the data augmentation method for the mapping relationship between the distribution of the steel bar corrosion and the distribution of the crack width provided by the above embodiment, and other technical features in the data augmentation device are the same as those disclosed in the method of the above embodiment, which will not be repeated here.

It should be understood that each part of the present application can be implemented by hardware, software, firmware, or a combination thereof. In the description of the above embodiments, specific features, structures, materials, or characteristics can be combined in any one or more embodiments or examples in an appropriate manner.

The above are only partial embodiments of the present application, and are not intended to limit the scope of the present application. Any equivalent structural transformation made through the description and accompanying drawings of the present application under the technical concept of the present application, or direct/indirect application in other related technical fields, is included in the scope of the present application.

What is claimed is:

1. A data augmentation method, comprising:
acquiring design parameters of a reinforced concrete beam member and corrosion experiment sample data of the reinforced concrete beam member conforming to the design parameters, wherein the corrosion experiment sample data comprises mapping relationship data between a spatial distribution of a steel corrosion rate and a distribution of a crack width on a surface of the reinforced concrete beam member;
establishing a finite element model of a reinforced concrete beam based on the design parameters;
establishing a steel corrosion expansion model; and
taking the steel corrosion expansion model as a boundary condition, inputting the corrosion experiment sample data into the finite element model of the reinforced concrete beam to calibrate a behavior of the finite element model of the reinforced concrete beam in simulating a surface concrete cracking caused by a concrete surface corrosion expansion, and generating augmented mapping relationship data between a calibrated spatial distribution of the steel corrosion rate and the distribution of the crack width.

2. The method according to claim 1, wherein the acquiring the design parameters of the reinforced concrete beam member and the corrosion experiment sample data of the reinforced concrete beam member conforming to the design parameters comprises:
acquiring the design parameters of the reinforced concrete beam member, wherein the design parameters comprise a member length, a cross-sectional dimension, a concrete strength, a thickness of a protection layer, and a diameter of a steel bar; and
acquiring the corrosion experiment sample data of the reinforced concrete beam member conforming to the design parameters obtained by accelerated corrosion through electrification.

3. The method according to claim 2, wherein the acquiring the corrosion experiment sample data of the reinforced concrete beam member conforming to the design parameters obtained by accelerated corrosion through electrification comprises:
acquiring first corrosion experiment sample data of the reinforced concrete beam member conforming to the design parameters obtained by accelerated corrosion through electrification under different current conditions, wherein the first corrosion experiment sample data comprises mapping relationship data between a spatial distribution of the steel corrosion rate along a length direction of the steel bar and the distribution of the crack width under different current conditions;
determining a spatial distribution of the steel corrosion rate under different corrosion rates based on the spatial distribution of the steel corrosion rate along the length direction of the steel bar under different current conditions;
determining an average corrosion rate of the steel bar based on the spatial distribution of the steel corrosion rate under different corrosion rates; and
generating mapping relationship data between the spatial distribution of the steel corrosion rate and the distribution of the crack width based on the average corrosion rate of the steel bar.

4. The method according to claim 3, wherein the taking the steel corrosion expansion model as the boundary condition, inputting the corrosion experiment sample data into the finite element model of the reinforced concrete beam to calibrate the behavior of the finite element model of the reinforced concrete beam simulating the surface concrete cracking caused by the concrete surface corrosion expansion, and generating augmented mapping relationship data between the calibrated spatial distribution of the steel corrosion rate and the distribution of the crack width comprises:
determining the average corrosion rate of the steel bar and a standard deviation of the steel bar corrosion rate based on the corrosion experiment sample data, and determining a logarithmic function relationship between the average corrosion rate of the steel bar and the standard deviation of the steel bar corrosion rate through a fitting method;
introducing a correlation equation for a finite element simulation, and determining a correlation distance parameter of the correlation equation for the finite element simulation based on the design parameters;
taking the steel corrosion expansion model as the boundary condition, calculating an expansion displacement of each unit of the finite element model of the reinforced concrete beam based on the correlation equation for the finite element simulation to perform a finite element simulation of a process of the surface concrete cracking caused by the concrete surface corrosion expansion; and
inputting the logarithmic function relationship into the finite element model of the reinforced concrete beam, generating the spatial distribution of the steel corrosion rate conforming to the logarithmic function relationship and a corresponding distribution of the crack width, and acquiring the augmented mapping relationship data between the calibrated spatial distribution of the steel corrosion rate and the distribution of the crack width.

5. The method according to claim 4, wherein the inputting the logarithmic function relationship into the finite element model of the reinforced concrete beam, generating the spatial distribution of the steel corrosion rate conforming to the logarithmic function relationship and the corresponding distribution of the crack width comprises:
inputting the logarithmic function relationship into the finite element model of the reinforced concrete beam, and simulating variability characteristic parameters of a corrosion space through Nataf transformation to generate the spatial distribution of the steel corrosion rate conforming to the logarithmic function relationship and the corresponding distribution of the crack width.

6. The method according to claim 4, wherein the correlation equation for the finite element simulation comprises an exponential correlation function, and the exponential correlation function is:
$${ρ}_{i , j} = exp ( - \frac{\vert τ \vert}{L} )$$
wherein ρ_{i,j} is a function value of a correlation of corrosion between steel bar units, L is the correlation distance parameter of the correlation equation, and τ=xᵢ-xⱼ is a center distance between two adjacent steel bar units along the length direction of the steel bar.

7. The method according to claim 1, wherein the establishing the finite element model of the reinforced concrete beam based on the design parameters comprises:
establishing a concrete model through introducing an eight-node solid element based on the design parameters;
simulating a tensile behavior of the concrete model through introducing a linear softening curve of fracture energy based on the concrete model; and
establishing a three-dimensional finite element model of the reinforced concrete beam based on the tensile behavior of the concrete model.

8. The method according to claim 1, wherein the establishing the steel corrosion expansion model comprises:
introducing a rust distribution curve of an elliptic expression to simulate a rust expansion behavior of each cross-section of the steel bar, and establishing the steel corrosion expansion model; wherein the rust distribution curve of the elliptic expression is:
$${u}_{θ} = \{ \begin{matrix}{u}_{2} & 0 ° \leq θ \leq 180 ° \\ \frac{( R + {u}_{1} ) \cdot ( R + {u}_{2} )}{\sqrt{{( R + {u}_{1} )}^{2} {cos}^{2} θ \cdot {( R + {u}_{2} )}^{2} {sin}^{2} θ}} - R & 180 ° < θ \leq 360 °\end{matrix}$$
wherein, u_{θ} is a function value of the rust distribution curve, R is an original radius of the steel bar, u₁ is a maximum thickness of a corrosion layer closest to a concrete surface, u₂ is a thickness of the corrosion layer on one side of the steel bar away from the concrete surface, and u_{θ} is a function value of the rust distribution curve of the elliptic expression.

9. The method according to claim 1, wherein the taking the steel corrosion expansion model as the boundary condition, inputting the corrosion experiment sample data into the finite element model of the reinforced concrete beam to calibrate the behavior of the finite element model of the reinforced concrete beam simulating the surface concrete cracking caused by the concrete surface corrosion expansion, and generating augmented mapping relationship data between the calibrated spatial distribution of the steel corrosion rate and the distribution of the crack width comprises:
taking the steel corrosion expansion model as the boundary condition, inputting the corrosion experiment sample data into the finite element model of the reinforced concrete beam to calibrate the behavior of the finite element model of the reinforced concrete beam simulating surface concrete cracking caused by concrete surface corrosion expansion, cyclically executing the step of generating the augmented mapping relationship data between the calibrated spatial distribution of the steel corrosion rate and the distribution of the crack width, and stopping executing the step of generating the augmented mapping relationship data between the calibrated spatial distribution of the steel corrosion rate and the distribution of the crack width after a data volume of the augmented mapping relationship data reaches a preset target data volume.

10. A data augmentation device, comprising: a memory, a processor, and a computer program stored on the memory and executable on the processor, wherein the computer program is configured to implement the data augmentation method according to claim 1.
